(19) United States
(12) Patent Application Publication
(10) Pub. No.: US 2025/0199895 A1
(43) Pub. Date: Jun. 19, 2025

(54) AUTOMATED LARGE-SCALE FAILURE MODE EFFECTS ANALYSIS SYSTEM

(71) Applicant: Express Scripts Strategic Development, Inc., St. Louis, MO (US)

(72) Inventors: Steven Sefton, Excelsior, MN (US); Neil J. Powell, St. Louis, MO (US); Marek Gromadzki, Montville, NJ (US)

(21) Appl. No.: 18/541,125

(22) Filed: Dec. 15, 2023

(51) Int. Cl. G06F 11/00

(52) U.S. Cl. CPC G06F 11/008

(57) ABSTRACT

A computer-implemented method for conducting failure mode effects analysis (FMEA) at a large scale includes generating a set of failure modes. The method includes determining an impact score for one of the set of failure modes. The method includes determining a probability score for one of the set of failure modes. The method includes determining a detectability score for one of the set of failure modes. The method includes calculating risk priority scores for the failure modes based on the impact score, the probability score, and the detectability score. The method includes ranking the failure modes according to the calculated risk priority scores. The method includes generating a report including the ranked failure modes.

### FIELD

The present disclosure relates to automation software and more particularly to software for large-scale failure mode and effects analysis (FMEA).

### SUMMARY

A computer-implemented method for conducting failure mode effects analysis (FMEA) at a large scale includes generating a set of failure modes. Each of the failure modes is associated with at least one of a software system, a software product, or a software process. The method includes determining an impact score for one of the set of failure modes. The impact score is associated with a score that is a measure of a severity of a failure mode. The method includes determining a probability score for one of the set of failure modes. The probability score is associated with a score that is a measure of a frequency in which a failure mode is expected to occur. The method includes determining a detectability score for one of the set of failure modes. The detectability score is associated with a score that is a measure of a likelihood of detecting a failure mode. The method includes calculating risk priority scores for the failure modes based on the impact score, the probability score, and the detectability score. The method includes ranking the failure modes according to the calculated risk priority scores. The method includes generating a report including the ranked failure modes.

In other features, generating the set of failure modes includes generating a FMEA artifact associated with at least one among the software system, the software product, and the software process. The method includes determining a set of dependencies for the FMEA artifact. A dependency is associated with a least one among a system, an application, a platform, and a component in which the at least one among the software system, the software product, and the software process requires to function properly. The method includes determining one or more failure modes associated with the set of dependencies. In other features, determining the one or more failure modes associated with the set of dependencies includes querying one or more databases to select data associated with failure modes of the set of dependencies.

In other features, the method includes assigning a set of organization members to each failure mode of the set of failures modes. In other features, assigning the set of organization members to each of the failure modes includes querying one or more databases to select the set of organization members. In other features, the method includes generating an additional report by associating one or more organization members to each of the failure modes, ranking the organization members according to the organization members associated with a highest number of failure modes, and generating the additional report including the ranked organization members.

In other features, the method includes determining a root cause for each of the set of failure modes. The root cause is associated with a fundamental factor that if addressed can mitigate an occurrence of a failure mode. In other features, the method includes determining an improvement plan for each of the set of failure modes. The improvement plan is associated with a plan to reduce the severity or an occurrence of a failure mode. In other features, the method includes selecting a failure mode of the set of failure modes, executing a failure mode simulation to test the selected failure mode, and generating an additional report including results of the failure mode simulation. In other features, the method includes displaying the report on an interactive user interface.

A system includes processor hardware and memory hardware configured to store instructions that, when executed by the processor hardware, cause the processor hardware to perform operations. The operations include generating a set of failure modes. Each of the failure modes is associated with at least one of a software system, a software product, or a software process. The operations include determining an impact score for one of the set of failure modes. The impact score is associated with a score that is a measure of a severity of a failure mode. The operations include determining a probability score for one of the set of failure modes. The probability score is associated with a score that is a measure of a frequency in which a failure mode is expected to occur. The operations include determining a detectability score for one of the set of failure modes. The detectability score is associated with a score that is a measure of a likelihood of detecting a failure mode. The operations include calculating risk priority scores for the failure modes based on the impact score, the probability score, and the detectability score. The operations include ranking the failure modes according to the calculated risk priority scores. The operations include generating a report including the ranked failure modes.

In other features, generating the set of failure modes includes generating a FMEA artifact associated with at least one among the software system, the software product, and the software process. The operations include determining a set of dependencies for the FMEA artifact. A dependency is associated with a least one among a system, an application, a platform, and a component in which the at least one among the software system, the software product, and the software process requires to function properly. The operations include determining one or more failure modes associated with the set of dependencies. In other features, determining the one or more failure modes associated with the set of dependencies includes querying one or more databases to select data associated with failure modes of the set of dependencies.

In other features, the operations further include assigning a set of organization members to each failure mode of the set of failures modes. In other features, assigning the set of organization members to each of the failure modes includes querying one or more databases to select the set of organization members. In other features, the operations further include generating an additional report by associating one or more organization members to each of the failure modes, ranking the organization members according to the organization members associated with a highest number of failure modes, and generating the additional report including the ranked organization members.

In other features, the operations further include determining a root cause for each of the set of failure modes. The root cause is associated with a fundamental factor that if addressed can mitigate an occurrence of a failure mode. In other features, the operations further include determining an improvement plan for each of the set of failure modes. The improvement plan is associated with a plan to reduce the severity or an occurrence of a failure mode. In other features, the operations further include selecting a failure mode of the set of failure modes, executing a failure mode simulation to test the selected failure mode, and generating an additional report including results of the failure mode simulation.

A non-transitory computer-readable medium storing processor-executable instructions, the instructions includes generating a set of failure modes. Each of the failure modes is associated with at least one of a software system, a software product, or a software process. The instructions include determining an impact score for one of the set of failure modes. The impact score is associated with a score that is a measure of a severity of a failure mode. The instructions include determining a probability score for one of the set of failure modes. The probability score is associated with a score that is a measure of a frequency in which a failure mode is expected to occur. The instructions include determining a detectability score for one of the set of failure modes. The detectability score is associated with a score that is a measure of a likelihood of detecting a failure mode. The instructions include calculating risk priority scores for the failure modes based on the impact score, the probability score, and the detectability score. The instructions include ranking the failure modes according to the calculated risk priority scores. The instructions include generating a report including the ranked failure modes.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIG. 4 is a functional block diagram of an example FMEA system.

FIG. 5 is a block diagram showing example data structures that may be stored in data stores of a system.

FIG. 6 is a flowchart of an example process for executing FMEA.

FIG. 7 is a flowchart of an example process for generating a FMEA artifact.

FIG. 8 is a flowchart of an example process for executing failure mode simulation.

FIG. 9 is a flowchart of an example process for executing FMEA.

FIG. 10 is a flowchart of an example process for importing data associated with a system, a product, and/or a process under review of FMEA.

FIG. 11 is a flowchart of an example process for generating new FMEA artifacts.

FIG. 12 is a flowchart of an example process for analyzing and/or simulating failure modes.

FIG. 13 is a flowchart of an example process for determining and facilitating execution of remediation actions for failure modes.

FIGS. 14-19 are graphical illustrations of example user interfaces used in connection with a FMEA system.

FIGS. 20 and 21 are graphical illustrations of example reports generated via a FMEA system.

In the drawings, reference numbers may be reused to identify similar and/or identical elements.

### DETAILED DESCRIPTION

### High-Volume Pharmacy

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104.

The system 100 may also include one or more user device(s) 108. A user, such as a pharmacist, patient, data analyst, health plan administrator, etc., may access the benefit manager device 102 or the pharmacy device 106 using the user device 108. The user device 108 may be a desktop computer, a laptop computer, a tablet, a smartphone, etc.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in a storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the pharmacy system 100) following performance of at least some of the aforementioned operations.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfillment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, age, date of birth, address (including city, state, and zip code), telephone number, e-mail address, medical history, prescription drug history, etc. In various implementations, the prescription drug history may include a prior authorization claim history-including the total number of prior authorization claims, approved prior authorization claims, and denied prior authorization claims. In various implementations, the prescription drug history may include previously filled claims for the member, including a date of each filled claim, a dosage of each filled claim, the drug type for each filled claim, a prescriber associated with each filled claim, and whether the drug associated with each claim is on a formulary (e.g., a list of covered medication).

In various implementations, the medical history may include whether and/or how well each member adhered to one or more specific therapies. The member data 120 may also include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. In various implementations, the member data 120 may include an eligibility period for each member. For example, the eligibility period may include how long each member is eligible for coverage under the sponsored plan. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member). In various implementations, the claims data 122 may include a percentage of prior authorization cases for each prescriber that have been denied, and a percentage of prior authorization cases for each prescriber that have been approved.

The drug data 124 may include drug name (e.g., technical name and/or common name), other names by which the drug is known, active ingredients, an image of the drug (such as in pill form), etc. The drug data 124 may include information associated with a single medication or multiple medications. For example, the drug data 124 may include a numerical identifier for each drug, such as the U.S. Food and Drug Administration's (FDA) National Drug Code (NDC) for each drug.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may be comprised of order components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

### FMEA System

Failure mode and effects analysis (FMEA) is a systematic and proactive approach used to identify potential failures, causes of the failures, and effects of the failures in various systems, products, and/or processes. Performing the FMEA enables an organization to anticipate and address the potential failures before they occur, implement preventive measures and/or design changes to minimize risks associated with the failures, and/or improve the overall reliability and performance of the organization's systems, products, and/or processes.

Typically, performing the FMEA involves gathering a group of individuals associated with a particular system, product, and/or process that is under review and brainstorming all of the potential failures, causes of the failures, effects of the failures, and/or workable solutions to minimize the risks associated with the failures. Spreadsheets (for example, Excel spreadsheets) are used to document and/or track the FMEA. Using the spreadsheets in connection with the FMEA is inefficient, time consuming, and cumbersome. For example, data is entered into the spreadsheets manually and is therefore prone to human errors. Additionally, using the spreadsheets does not permit an organization to conduct the FMEA at a large scale. For example, the organization may desire to perform the FMEA for a significant number of the organization's systems, products, and/or processes and aggregating and/or querying data from the spreadsheets is evidenced to be challenging and/or unfeasible.

Returning to FIG. 1, the system 100 may include a failure mode effects analysis (FMEA) system 400 capable of executing the FMEA at a large scale. More specifically, the FMEA system 400 is capable of executing, documenting, tracking, and/or reporting the FMEA for a significant number (for example, 10 or more, 100 or more, 1000 or more, etc.) systems, products, and/or processes. In various implementations, the FMEA system 400 is capable of aggregating and/or querying a large amount of data (for example, at least 1 GB, at least 1 TB, at least 1 PB, etc.) such to execute the FMEA and/or generate various reports associated with the FMEA, among others. Various features of the FMEA system 400 may be automated such to enable fast, efficient, and/or accurate execution of the FMEA as further described herein.

In various implementations, the systems, the products, and/or the processes under review of the FMEA may be associated with software. For example, a system may include an operating system, an enterprise resource planning (ERP) system, a customer relationship management system (CMS), an electronic health record (EHR) system, a picture archiving and communication system (PACS), a laboratory information management system (LIMS), a clinical decision support system (CDSS), a telehealth platform, a hospital information system (HIS), a pharmacy management system, a health information exchange (HIE), a transportation management system (TMS), an E-Commerce platform, a learning management system (LMS), a social media platform, and/or a database system (DBMS), among others. A product may include a software application, a software program, and/or a software service, among others. A process may include a process associated with a set of activities, methods, and/or practices that may be followed during the development, maintenance, and/or deployment of various software systems, applications, and/or programs.

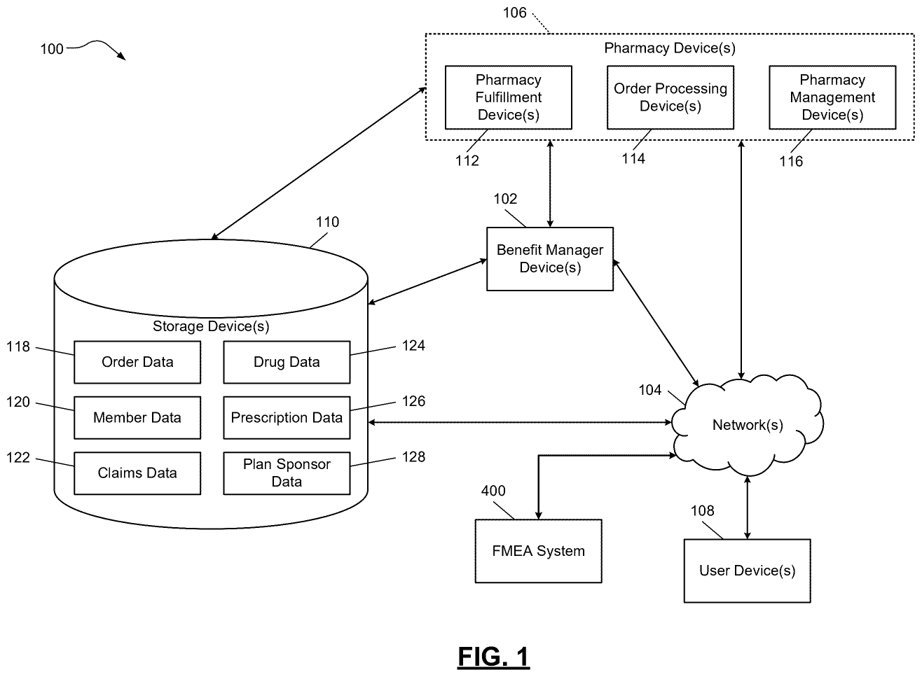

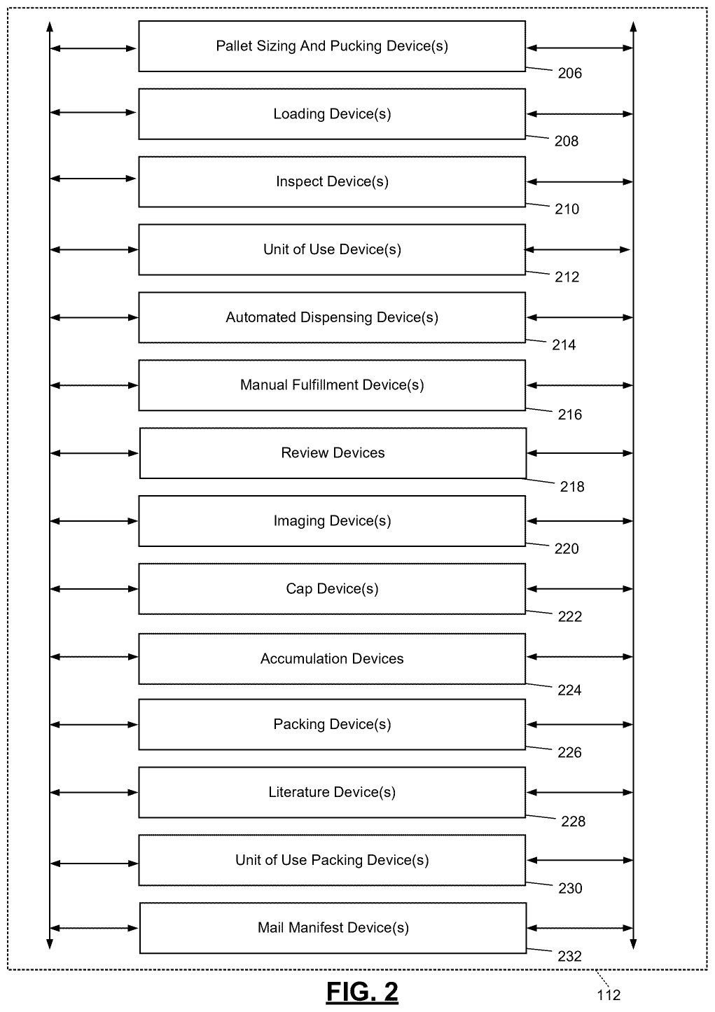

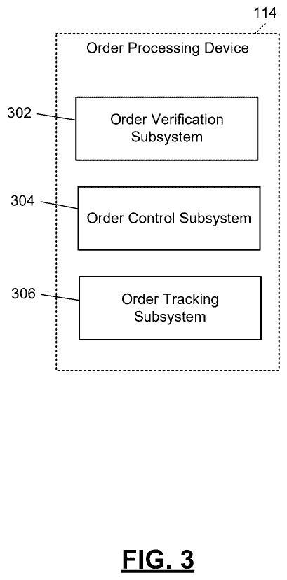

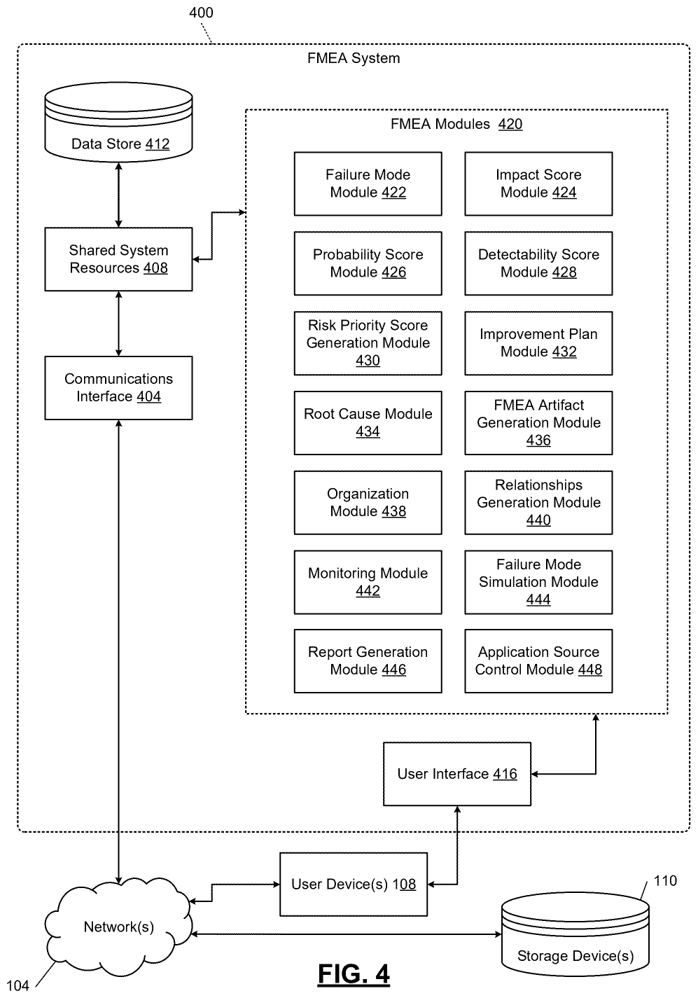

FIG. 4 is a functional block diagram of an example FMEA system 400. As shown in FIG. 4, the FMEA system 400 may include a communications interface 404, shared system resources 408, one or more data stores including non-transitory computer-readable storage media, such as data store 412, a user interface 416, and one or more FMEA modules 420. In various implementations, the communications interface 404 may be suitable for communicating with other communications interfaces over the network 104. In various implementations, the communications interface 404 may include a transceiver suitable for sending and/or receiving data to and from other communications interfaces over the network 104. In various implementations, the shared system resources 408 may include one or more processors, volatile and/or non-volatile computer memory such as random-access memory, system storage-such as non-transitory computer-readable storage media, and one or more system buses connecting the components.

In various implementations, the communications interface 404, the FMEA modules 420, and/or the data store 412 may be operatively coupled to the shared system resources 408 and/or the operatively coupled to each other through the shared system resources 408. In various implementations, the FMEA modules 420 may be software modules stored on non-transitory computer-readable storage media. In various implementations, the FMEA modules 420 may include a failure mode module 422, an impact score module 424, a probability score module 426, a detectability score module 428, a risk priority score generation module 430, an improvement plan module 432, a root cause module 434, a FMEA artifact generation module 436, an organization module 438, a relationships generation module 440, a monitoring module 442, a failure mode simulation module 444, a report generation module 446, and an application source control module 448.

The failure mode module 422 may be configured to select, retrieve, determine, and/or generate one or more failure modes associated with the system, the product, and/or the process under review (i.e., the system, the product, and/or the process that the FMEA is being conduct for). In various implementations, a failure mode may include a potential way in which the system, the product, and/or the process could fail to perform its intended function. The failure mode may represent a specific event or condition that may lead to a deviation and/or malfunction. In various implementations, a failure mode associated with software may vary depending on the specific software system, product, and/or process, its complexity, and/or the context in which it is used. A failure mode may include a software bug and/or error, a system, application, and/or program crash and/or freeze, a performance degradation, a security vulnerability, a compatibility issue, a data corruption and/or loss, an integration failure, a user interface issue, a network and/or connectivity problem, and/or a third-party service dependency, among others. The failure mode module 422 may be configured to carry out various other functions in connection with FMEA as described further in the specification.

The impact score module 424 may be configured to select, retrieve, determine, and/or generate an impact score for each of the failure modes associated with the system, the product, and/or the process under review. In various implementations, the impact score may be associated with a severity score that is a measure of the potential impact and/or seriousness of a failure mode. The impact score may be used to assess the severity of the consequences that may result from the failure. In some examples, the impact score may include a numerical scale (for example, 1 to 100, 1 to 10, 1 to 5, etc.) in which the higher the impact score, the greater the potential impact and/or severity of the failure mode. In some instances, the impact score may include a user defined classification (for example, high, low, and/or moderate, among others). The impact score may be determined by considering the potential consequences of the failure such as in terms of safety, health, environmental impact, customer and/or end user satisfaction, and/or financial impact, among others.

The probability score module 426 may be configured to select, retrieve, determine, and/or generate a probability score for each of the failure modes associated with the system, the product, and/or the process under review. In various implementations, the probability score may be associated with an occurrence score that is a measure of the likelihood and/or frequency in which a particular failure mode is expected to occur. In some examples, the probability score may include a numerical scale (for example, 1 to 100, 1 to 10, 1 to 5, etc.) in which the higher the probability score, the greater the likelihood of the failure mode occurring. In some instances, the probability score may include a user defined classification (for example, high, low, and/or moderate, among others). The probability score may be determined by considering various factors such as historical data, engineering judgement, past experiences, and/or relevant statistical information, among others.

The detectability score module 428 may be configured to select, retrieve, determine, and/or generate a detectability score for each of the failure modes and/or for each of the root causes associated with the system, the product, and/or the process under review. In various implementations, the detectability score may be associated with a score that is a measure of the likelihood of detecting a failure mode and/or a root cause, for example, before it reaches an end user and/or before it causes harm. In some examples, the detectability score may include a numerical scale (for example, 1 to 100, 1 to 10, 1 to 5, etc.) in which the higher the detectability score, the lower the likelihood of detecting the failure mode. In some instances, the probability score may include a user defined classification (for example, high, low, and/or moderate, among others). The detectability score may be determined by considering various factors such as the effectiveness of existing detection methods, monitoring systems, quality controls, inspections, testing procedures, and/or other measures that are in place to identify and/or mitigate failures, among others.

The risk priority score generation module 430 may be configured to calculate, generate, and/or determine a risk priority score for each of the failure modes associated with the system, the product, and/or the process under review. In various implementations, the risk priority score may be associated with a score that combines the impact score, the probability score, and/or the detectability score (for example, the risk priority score=the impact score*the probability score*the detectability score). The risk priority score includes a numerical value (for example, 1 to 1,000, etc.) in which higher risk priority scores indicate higher priority for attention and/or mitigation of the associated failure mode. For example, the risk priority score may be used by the organization to prioritize addressing the failure modes.

In examples including a set of impact scores, a set of probability scores, and/or a set of detectability scores for a particular failure mode, the risk priority score generation module 430 may calculate the risk priority score by selecting the largest impact score of the set impact scores, the largest probability score of the set of probability scores, and/or the largest detectability score of the set of detectability scores. Alternatively, the risk priority score generation module 430 may calculate the risk priority score by using an impact score that is the average of the set of impact scores, a probability score that is the average of the set of probability scores, and/or a detectability score that is the average of the set of detectability scores.

The improvement plan module 432 may be configured to select, retrieve, determine, and/or generate an improvement plan for each of the failure modes associated with the system, the product, and/or the process under review. In various implementations, the improvement plan may be associated with a plan and/or a strategy to mitigate and/or eliminate a failure mode, reduce the severity and/or occurrence of the failure mode, and/or improve the detectability of the failure mode, among others. The improvement plan may include defined improvement actions, responsibility and/or resources assignments, timelines, monitoring plans, and/or review and/or update plans, among others. The improvement plan may be used to reduce the risks associated with a particular failure mode, enhance the system, the product, and/or the process under review, improve customer and/or end user satisfaction, and/or support continuous improvement efforts, among others.

The root cause module 434 may be configured to select, retrieve, determine, and/or generate a root cause for each of the failure modes associated with the system, the product, and/or the process under review. In various implementations, the root cause may be associated with the underlying reason and/or source that contributes to a particular failure mode. The root cause may be associated with the fundamental factor and/or factors that if addressed can prevent and/or mitigate the occurrence of the failure mode. The root cause may be determined by analyzing the effects of a particular failure mode, conducting a cause and effects analysis, verifying and/or validating a potential root cause, and/or documenting and/or addressing a potential root cause, among others.

The FMEA artifact generation module 436 may be configured to generate, create, and/or determine a set of failure mode artifacts associated with the system, the product, and/or the process under review. In various implementations, a FMEA artifact may include a failure mode and/or an initial failure mode, among others. The initial failure mode may include a failure mode that requires further analysis and/or processing, among others.

The organization module 438 may be configured to assign and/or associate a set of organization members to each of the failure modes associated with the system, the product, and/or the process under review. In various implementations, the organization members may include the owners of a particular failure mode whom are responsible for addressing, rectifying, testing, and/or monitoring the failure mode, among others.

The relationships generation module 440 may be configured to determine, create, and/or generate relationship and/or integrations mapping of the system, the product, and/or the process under review. The relationship and/or integrations mapping may be associated with the connections and/or interactions associated with different systems, applications, and/or platforms such to enable data sharing, functionality sharing, and/or coordinated workflows with the system, the product, and/or the process under review. The relationship and/or integrations mapping may include various forms such as application programming interface (API) integrations, middleware integrations, database integrations, E-commerce integrations, cloud integrations, and/or workflow integrations, among others.

In various implementations, the relationships generation module 440 may be configured to generate various diagrams depicting the relationships and/or the integrations associated with the system, the product, and/or the process under review. For example, the relationships generation module 440 may use nodes (for example, entities, etc.) and/or edges (for example, connections, etc.) to depict the relationships and/or integrations. The nodes may include various entities, such as various software systems, applications, and/or platforms associated with the system, the product, and/or the process under review. The edges may include the dependencies and/or the interactions between the nodes.

The monitoring module 442 may be configured to monitor, track, and/or collected data of various features associated with the system, the product, and/or the process under review. The failure mode simulation module 444 may be configured to simulate, model, and/or test the failure modes. In various implementations, the failure mode simulation module 444 may be configured to model and/or simulate the failure behavior and/or reliability of a particular system, product, and/or process. The failure mode simulation module 444 may be used to analyze and/or predict performance, failure modes, and/or lifetime characteristics of a particular system, product, and/or process under various operating conditions. The failure mode simulation module 444 may configured to facilitate the identification and/or analysis of potential failure modes to the system, the product, and/or the process. For example, the failure mode simulation module 444 may enable a user to define failure modes, the probabilities of the failure modes, the failure distributions, and/or the impact of the failure modes to the performance of the system, the product, and/or the process.

The report generation module 446 may be configured to generate various reports associated with the FMEA, the systems, the products, and/or the processes under review, and/or the failure mode simulation, among others. In various implementations, a report may display the organization members associated with particular systems, products, and/or processes and/or failure modes, among others. The reports may be used by the organization to help determine the allocation of certain organization resources (for example, monetary, organization member assignment, etc.) to address the failure modes, to track the progress completed by the organization in rectifying the failure modes, and/or to make informed business, decisions, among other.

The application source control module 448 may be configured to control the execution of one or more software applications associated with the FMEA. The application source control module 448 may be configured to assist users to track changes to their codebase over time. The application source control module 448 may permit multiple users to work on the same code project concurrently without conflicts and may enable the management of different versions or branches of the code. In various implementations, the application source control module 448 may be associated with an application source control system.

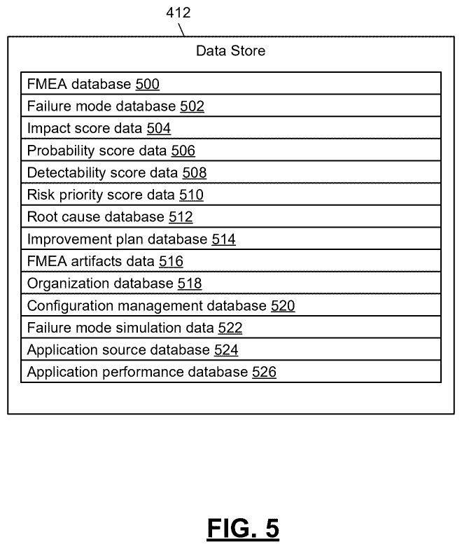

FIG. 5 is a block diagram showing example data structures that may be stored in data stores of the FMEA system 400. In various implementations, each of the data structures of data store 412 may include any combination of flat files and relational databases-such as Structured Query Language (SQL) tables. In various implementations, the data store 412 may include a FMEA database 500, a failure mode database 502, impact score data 504, probability score data 506, detectability score data 508, risk priority score data 510, a root cause database 512, an improvement plan database 514, FMEA artifacts data 516, an organization database 518, a configuration management database 520, a failure mode simulation data 522, an application source database 524, and an application performance database 526.

In various implementations, the FMEA database 500 may include one or more databases and/or data associated with previously conducted and/or in progress FMEA. In various implementations, the failure mode database 502 may include one or more databases and/or data associated with previously identified and/or in progress failure modes. In various implementations, the impact score data 504 may include data associated with previously determined and/or in progress impact scores. In various implementations, the probability score data 506 may include data associated with previously determined and/or in progress probability scores.

In various implementations, the detectability score data 508 may include data associated with previously determined and/or in progress detectability scores. In various implementations, the risk priority score data 510 may include data associated with previously generated and/or in progress risk priority scores. In various implementations, the root cause database 512 may include one or more databases and/or data associated with previously identified and/or in progress root causes. In various implementations, the improvement plan database 514 may include one or more databases and/or data associated with previously identified and/or in progress improvement plans. In various implementations, the FMEA artifacts data 516 may include data associated with previously generated and/or in progress FMEA artifacts. In various implementations, the organization database 518 may include one or more databases and/or data associated with members of the organization and/or the structure of the organization including the organization hierarchy of its members. The organization database 518 may include organization member data such as organizational units data, reporting relationships data, position titles data, levels of authority data, span of control data, and/or subsidiaries and/or branches data, among others.

In various implementations, the configuration management database 520 may include one or more databases and/or data associated with the configurations, relationships, and/or integrations associated with the organization's systems, products, and/or processes. The configuration management database 520 may include various component and/or dependency metrics associated with the organizations's systems, products, and/or processes. In some examples, each of the component and/or dependency metrics includes data associated with relationships and dependencies between components, modules, and/or packages of a particular organization system, product, and/or process. The configuration management database 500 may include application service records and/or code development records associated with the organization's systems, products, and/or processes. The application service records and/or code development records may indicate the organization members who are associated with the a particular system, product, and/or process.

In various implementations, the failure mode simulation data 522 may include data associated with and/or used to execute failure mode simulation of one or more the organization's systems, products, and/or processes. The failure mode simulation data 522 may include data associated with faults types and/or errors to be injected in the applicable systems and/or products to conduct the failure mode simulation.

In various implementations, the application source database 524 may include data and/or source code associated with the organizations's systems, products, and/or processes. In various implementations, the application performance database 528 may include one or more databases and/or data associated with various components and/or dependent metrics associated with the organizations's systems, products, and/or processes.

### Flowcharts

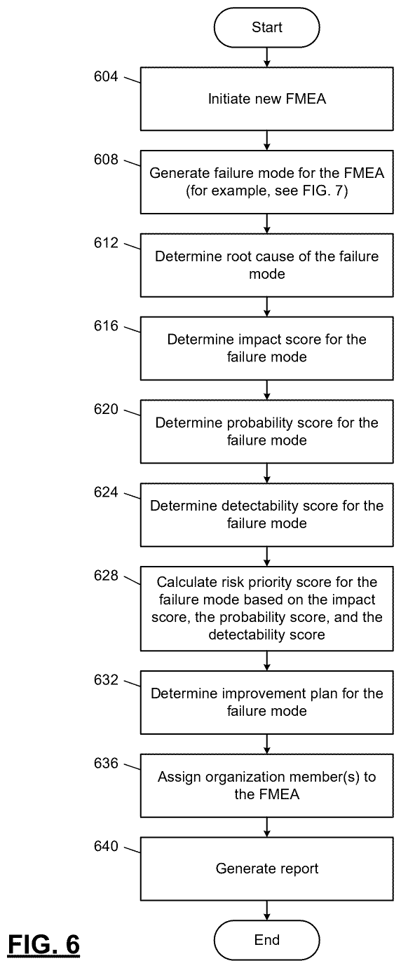

FIG. 6 is a flowchart of an example process for executing FMEA via the FMEA system 400. Control begins at 604. At 604, a user may initiate a new FMEA via the user interface 416. In various implementations, the user may select, input, and/or identify the system, the product, and/or the process to be under review of the FMEA. Control proceeds to 608.

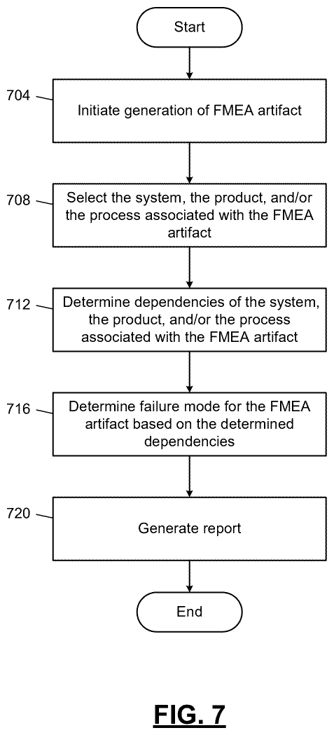

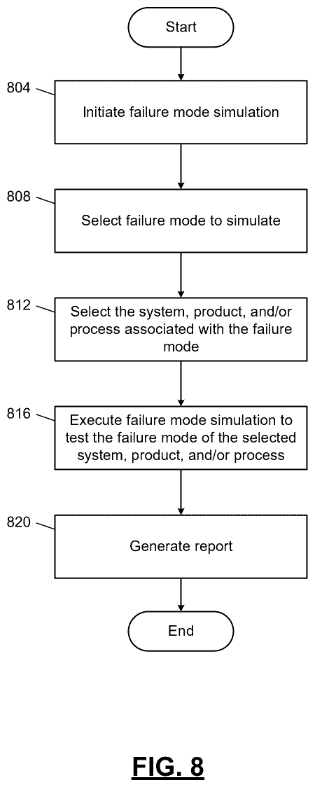

At 608, the failure mode module 422 may select, retrieve, determine, and/or generate one or more failure modes associated with the system, the product, and/or the process under review. In various implementations, the user may select, input, and/or identify the failure modes via the user interface 416. In some examples, the failure mode module 422 may query the failure mode database 502 such to retrieve data associated with the failure modes for further analyses, review, processing, and/or display. In some examples, the failure mode module 422 and/or the FMEA artifact generation module 440 may generate one or more FMEA artifacts (i.e., a new failure mode) associated with the system, the product, and/or the process under review. Additional details of generating the FMEA artifacts will be described further in this specification with reference to FIG. 7. Control proceeds to 612.

At 612, the root cause module 434 may select, retrieve, determine, and/or generate one or more root causes for each of the failure modes associated with the system, the product, and/or the process under review. In various implementations, the user may select, input, and/or identify the root causes for each of the failure modes via the user interface 416. In some examples, the root cause module 434 may query the root cause database 512 such to retrieve data associated with the root causes for further analyses, review, processing, and/or display. Control proceeds to 616.

At 616, the impact score module 424 may select, retrieve, determine, and/or generate an impact score for each of the failure modes associated with the system, the product, and/or the process under review. In various implementations, the user may select, input, and/or identify an impact score for each of the failure modes via the user interface 416. Control proceeds to 620.

At 620, the probability score module 426 may select, retrieve, determine, and/or generate a probability score for each of the failure modes associated with the system, the product, and/or the process under review. In various implementations, the user may select, input, and/or identify a probability score for each of the failure modes via the user interface 416. Control proceeds to 624.

At 624, the detectability score module 428 may select, retrieve, determine, and/or generate a detectability score for each of the failure modes and/or for each of the root causes associated with the system, the product, and/or the process under review. In various implementations, the user may select, input, and/or identify the detectability scores for the failure modes and/or the root causes via the user interface 416. Control proceeds to 628.

At 628, the risk priority score generation module 430 may calculate, generate, and/or determine a risk priority score for each of the failure modes associated with the system, the product, and/or the process under review. In various implementations, the risk priority score generation module 430 may calculate a risk priority score by combining the impact score, the probability score, and/or the detectability score (for example, the risk priority score=the impact score*the probability score*the detectability score). Control proceeds to 632.

At 632, the improvement plan module 432 may select, retrieve, determine, and/or generate an improvement plan for each of the failure modes associated with the system, the product, and/or the process under review. In various implementations, the user may select, input, and/or identify the improvement plan for each of the failure modes via the user interface 416. In some examples, the improvement plan module 432 may query the improvement plan database 514 such to retrieve data associated with the improvement plans for further analyses, review, processing, and/or display. Control proceeds to 636.

At 636, the organization module 438 may assign and/or associate a set of organization members for each of the failure modes associated with the system, the product, and/or the process under review. In various implementations, the user may select, input, and/or identify the organization members for each of the failure modes via the user interface 416. In some examples, the organization module 438 may query the organization database 518 to associate certain data with particular failure modes for further analyses, review, processing, and/or display. Control proceeds to 640.

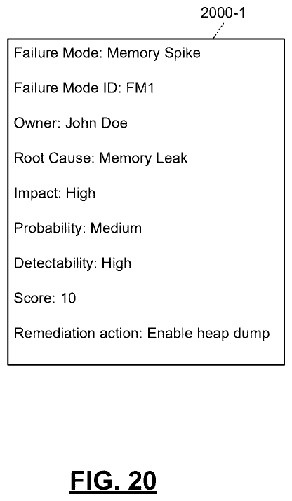

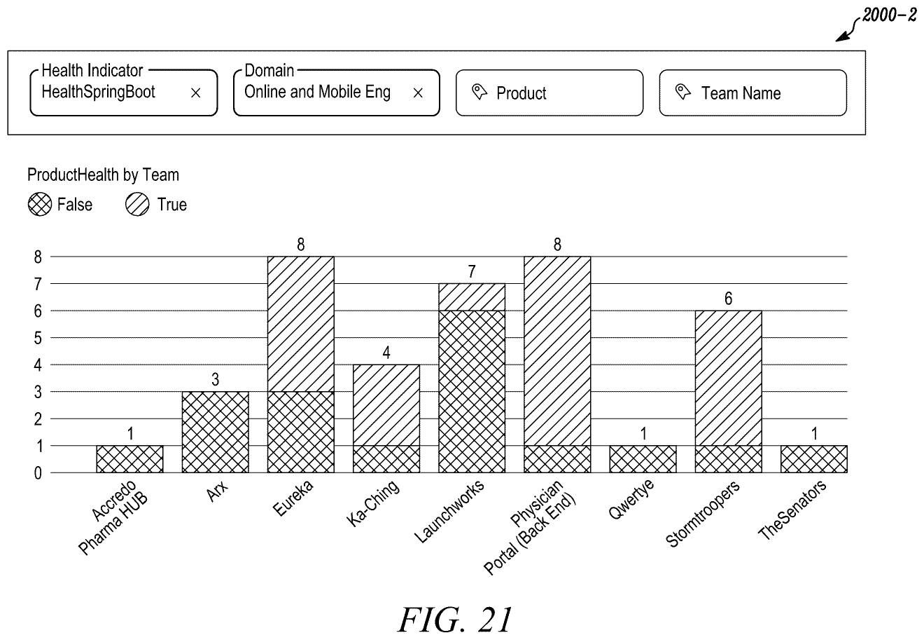

At 640, the report generation module 446 may generate one or more reports associated with the FMEA and/or the systems, the products, and/or the processes under review. Additional details of generating the reports will be described further in this specification with reference to FIGS. 20 and 21.

FIG. 7 is a flowchart of an example process for generating a FMEA artifact (i.e., a new failure mode). Control begins at 704. At 704, the user may initiate the generation of a FMEA artifact via the user interface 416. Control proceeds to 708.

At 708, the user may select, input, and/or identify the system, the product, and/or the process to be under review of the FMEA and/or associated with the FMEA artifact via the user interface 416. Control proceeds to 712.

At 712, the relationships generation module 440 may determine and/or identify one or more dependencies associated with the system, the product, and/or the process under review. In various implementations, a dependency may be associated with a software system, application, platform, and/or component in which the system, the product, and/or the process requires to function properly. A determined and/or identified dependency may indicate that the system, the product, and/or the process under review relies on the services, functionality, and/or resources provided by the dependency. In various implementations, the relationships generation module 440 may analyze data of the configuration management database 520 to extract and/or determine the relationships and/or integrations associated with the system, the product, and/or the process under review. The relationships generation module 440 may use the extracted and/or determined relationships and/or integrations to determine the dependencies. Control proceeds to 716.

At 716, the failure mode module 422 may select, retrieve, determine, and/or generate one or more failure modes associated with the system, the product, and/or the process under review based on the determined and/or identified dependencies. In various implementations, the failure mode module 422 may query the failure mode database 502 to select and/or extract data associated with the failure modes of the determined and/or identified dependencies. Control proceeds to 720.

At 720, the report generation module 446 may generate one or more reports associated with the failure modes of the systems, the products, and/or the processes under review. Additional details of generating the reports will be described further in this specification with reference to FIGS. 20 and 21.

FIG. 8 is a flowchart of an example process for executing a failure mode simulation such as to test a particular failure mode. Control begins at 804. At 804, a user may initiate the failure mode simulation via the user interface 416. Control proceeds to 808.

At 808, the user may select, input, and/or identify the failure mode to simulate via the user interface 416. Control proceeds to 812. At 812, the user may select, input, and/or identify the system, the product, and/or the process for the failure mode simulation. Control proceeds to 816.

At 816, the failure mode simulation module 444 may simulate, model, and/or test the selected failure mode. In various implementations, the failure mode simulation module 444 may inject one or more applicable software systems and/or products with one or more faults and/or errors to evaluate the behavior of the systems and/or products under review. In some examples, the user may select, input, and/or identify the types of faults and/or errors to be injected via the user interface 416. For example and without limitation, the faults and/or errors may include software bugs, hardware failures, network disruptions, and/or other faults and/or errors that may occur in real world scenarios, among others.

In various implementations, the failure mode simulation module 444 may introduce the selected faults and/or errors into the applicable systems and/or products. For example, the failure mode simulation module 444 may inject the faults and/or errors into specific software components, network communications, and/or hardware interfaces, among others. In some instances, the failure mode simulation module 444 may expose a specific application programming interface to run failure mode tests.

In various implementations, the failure mode simulation module 444 may introduce the faults and/or errors at random and/or based on defined scenarios to simulate the failure mode. In various implementations, the monitoring module 442 may monitor and/or record the behavior of the applicable systems and/or products during the simulation and/or during execution. The monitoring module 442 may collect data associated with how the systems and/or products respond to the simulation including collecting any error messages, system crashes, performance degradation, and/or unexpected behavior, among others. The collected data may be analyzed to evaluate the systems and/or the products response to the injected faults and/or errors. The collected data may be used to assess the systems and/or products resilience, determine the systems and/or products ability to recover, and/or identify any potential vulnerabilities and/or weaknesses that need to be addressed, among others. Control proceeds to 820.

At 820, the report generation module 446 may generate one or more reports associated with the failure mode simulation. Additional details of generating the reports will be described further in this specification with reference to FIGS. 20 and 21.

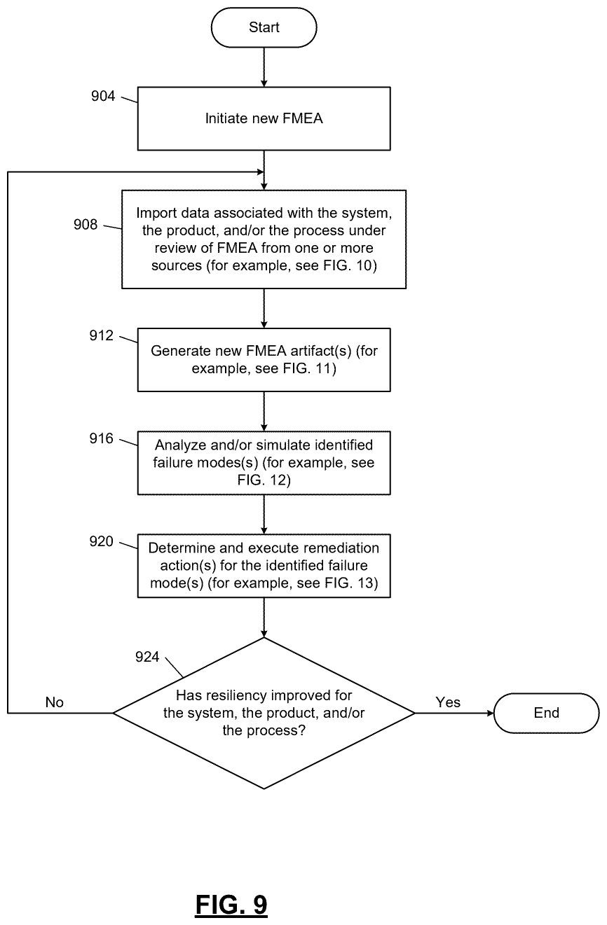

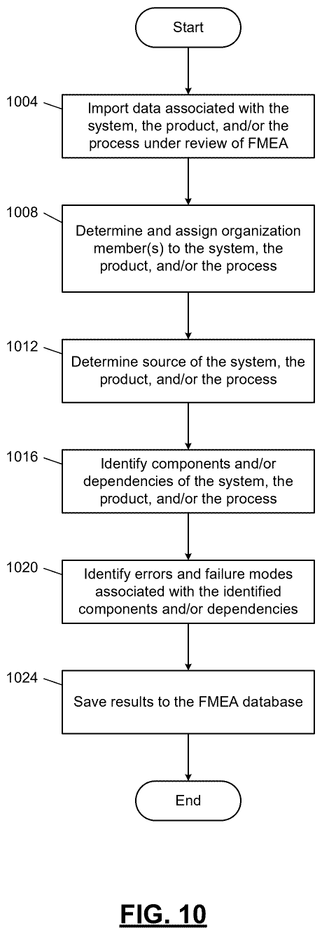

FIG. 9 is a flowchart of an example process for executing FMEA via the FMEA system 400. In various implementation, the FMEA may be executed at least semi-autonomously with minimal user interaction. Controls begins at 904. At 904, a user may initiate a new FMEA via a user interface. In various implementations, the user may select, input, and/or identify the system, the product, and/or the process to be under review of the FMEA. Control proceeds to 908. At 908, in response to the user initiating the new FMEA, the failure mode module 422 and/or the application source control module 448 may automatically import data associated the system, the product, and/or the process under review of the FMEA from one or more external systems and/or data sources. Additional details of importing the data associated with the system, the product, and/or the process will be described further in this specification with reference to FIG. 10. Control proceeds to 912.

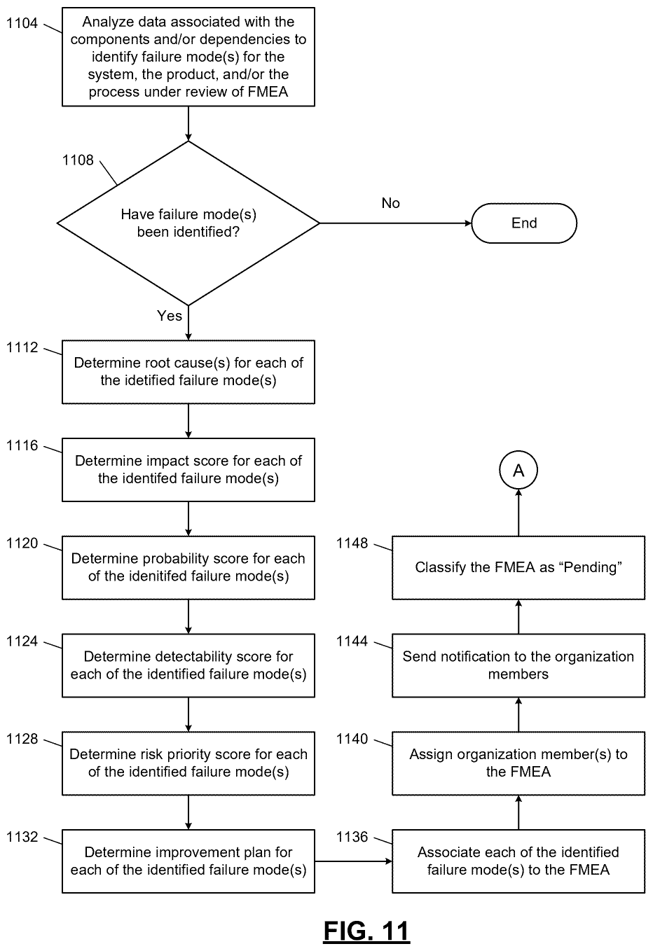

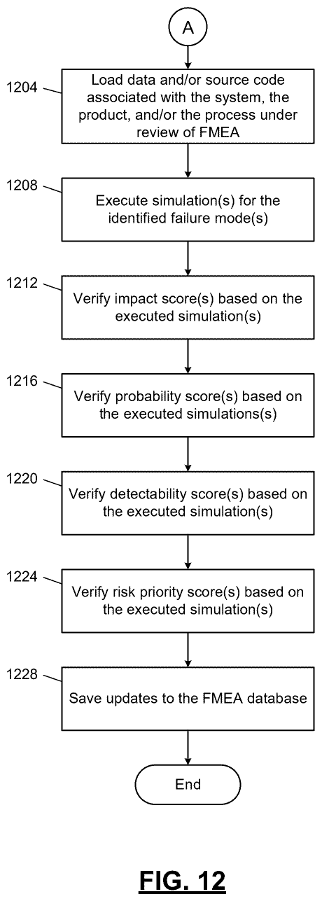

At 912, in response to the importing of the data, the FMEA artifact generation module 436 may automatically generate one or more new FMEA artifacts associated with the system, the product, and/or the process under review of the FMEA. Additional details of generating the new FMEA artifacts will be described further in this specification with reference to FIG. 11. Control proceeds to 916. At 916, in response to the generation of the new FMEA artifacts, the failure mode simulation module 444 may automatically analyze and/or simulate identified failure modes. Additional details of analyzing and/or simulating the identified failure modes will be described further in this specification with reference to FIG. 12. Control proceeds to 920.

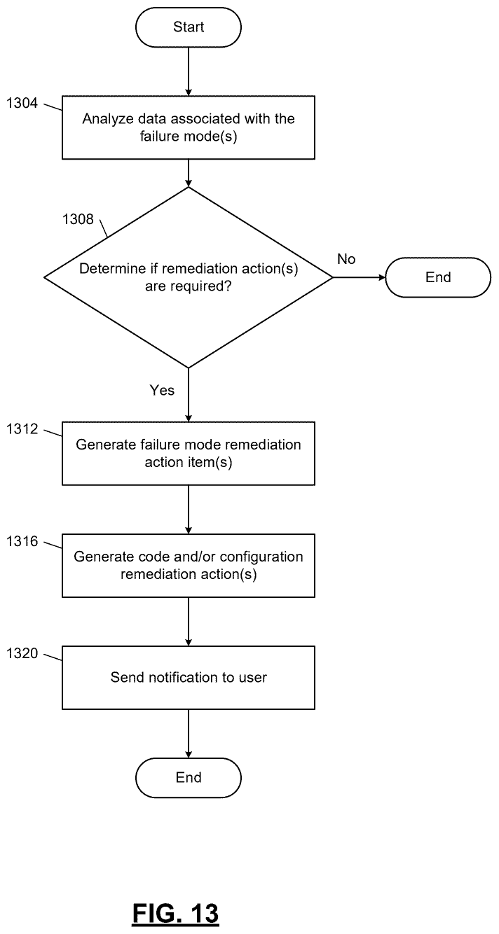

At 920, in response to executing the one or more failure mode simulations, the failure mode simulation module 444 may automatically determine and facilitate the execution of one or more remediation actions for the identified failure modes. Additional details of executing the remediation actions for the failure modes will be described further in this specification with reference to FIG. 13. Control proceeds to 924. At 924, in response to the execution of the remediation actions, the monitoring module 442 may automatically determine if resiliency of the system, the product, and/or process under review of the FMEA has improved. If no at 924, then control proceeds to 910. If yes at 924, then control ends.

FIG. 10 is a flowchart of an example process for importing data associated with the system, the product, and/or the process under review of the FMEA. Control begins at 1004. At 1004, the failure mode module 422 and/or the application source control module 448 may automatically import data from the configuration management database 520 associated with the system, the product, and/or the process under review of the FMEA. In examples including a software application under review of the FMEA, the failure mode module 422 and/or the application source control module 448 may import application service records and/or code development records associated with the software application from the configuration management data 520. Control proceeds to 1008.

At 1008, in response to importing the data, the organization module 438 and/or the relationships generation module 440 may automatically determine and assign one or more organization members to the system, the product, and/or the process under review of the FMEA. The organization module 438 and/or the relationships generation module 440 may determine and assign the organization members via one or more processes described herein. In examples including a software application, the organization module 438 and/or the relationships generation module 440 may process the application service records and/or the code development records to determine and assign the organization members to the system, the product, and/or the process. Control proceeds to 1012.

At 1012, the application source control module 448 may determine and/or import the source of the system, the product, and/or the process under review of the FMEA from the application source database 524. In various implementations, the source may include programming code, configuration files, data files, and/or any other asset required to build and run software associated with the system, the product, and/or the process. Control proceeds to 1016.

At 1016, in response to determining and/or importing the source, the relationships generation module 440 and/or the application source control module 448 may automatically identify components and/or dependencies of the system, the product, and/or the process under review of the FMEA. The relationships generation module 440 and/or the application source control module 448 may identify the components and/or the dependencies via one or more processes described herein. In some examples, the relationships generation module 440 and/or the application source control module 448 may import and/or process one or more component and/or dependency metrics associated with the system, the product, and/or process to identify the components and/or the dependencies. Control proceeds to 1020.

At 1020, in response to the identifying the components and/or the dependencies, the failure mode module 422 may automatically identify any known errors and/or failure modes associated with the identified components and/or dependencies. The failure mode module 422 may identify the errors and/or the failure modes associated with the components and/or the dependencies via one or more process described herein. Control proceeds to 1024. At 1024, the failure mode module 422 may associate and/or link the identified errors and/or failure modes with the system, the product, and/or the process under review of the FMEA and may save the results to the FMEA database 500. Then control ends.

FIG. 11 is a flowchart of an example process for generating new FMEA artifacts (i.e., failure modes) associated with the system, the product, and/or the process under review of the FMEA. Control begins at 1104. At 1104, the failure mode module 422 may analyze, cross reference, and/or read data associated with the components and/or the dependencies of the system, the product, and/or the process from the FMEA database 500, the failure mode database 502, the configuration management database 520, and/or the application source database 524 to determine and/or identify one or more failure modes for the system, the product, and/or the process under review of the FMEA. Control proceeds to 1108.

At 1108, the failure mode module 422 may determine if any failure modes have been detected and/or identified. If no at 1108, control ends. If yes at 1108, control proceeds to 1112.

At 1112, the root cause module 434 may automatically determine one or more root causes for each of the identified failure modes. The root cause module 434 may determine the root causes via one or more processes described herein. Control proceeds to 1116. At 1116, in response to determining the root causes, the impact score module 424 may automatically determine an impact score for each of the identified failure modes. The impact score module 424 may determine the impact scores via one or processes described herein Control proceeds to 1120.

At 1120, in response to determining the impact scores, the probability score module 426 may automatically determine a probability score for each of the identified failure modes. The probability score module 426 may determine the probability scores via one or processes described herein. Control proceeds to 1124. At 1124, in response to determining the probability scores, the detectability score module 428 may automatically determine a detectability score for each of the identified failure modes. The detectability score module 428 may determine the detectability scores via one or more processes described herein. Control proceeds to 1128.

At 1128, in response to determining the detectability scores, the risk priority score generation module 430 may automatically determine a risk priority score for each of the identified failure modes. The risk priority score module 430 may determine the risk priority scores via one or processes described herein. Control proceeds to 1132. At 1132, in response to the determining the risk priority scores, the improvement plan module 432 may automatically determine one or more improvement plans for each of the identified failure modes. The improvement plan module 432 may determine the improvement plans via one or more processes described herein. Control proceeds to 1136.

At 1136, in response to determining the improvement plans, the failure mode module 422 may assign, associate, and/or save each of the identified failure mode to the FMEA under review. The failure mode module 422 may save the results to the FMEA database 500. Control proceeds to 1140. At 1140, in response to assigning, associating, and/or saving each of the identified failure modes to the FMEA under review, the organization module 438 may automatically assign one or more organization members to each of the identified failure modes. Control proceeds to 1144. At 1144, in response to assigning the organization members, the organization module 438 may automatically generate and send a notification (for example, an electronic message such as an email, etc.) to the each of the organization members assigned to a particular failure mode such that each of the organization members can execute one or more subsequent actions. Control proceeds to 1148.

At 1148, in response to sending the notifications, the failure mode module 422 may save, classify, and/or identify the FMEA under review as “Pending” for further processing via the FMEA system 400. The failure mode module 422 may save the classification to the FMEA database 500. A FMEA classified as “Pending” may include one or more failure modes that require further processing such as failure mode simulation and/or remediation, among others. Control proceeds to 1204 of FIG. 12.

FIG. 12 is a flowchart of an example process for analyzing and/or simulating the identified failure modes. Control begins at 1204. At 1204, the failure mode simulation module 444 may select and/or load data and/or source code associated with the system, the product, and/or the process under review of FMEA to execute one or more simulations of the identified failure modes. For example, the failure mode simulation module 444 may query the FMEA database 500 and/or the application source database 524 to obtain the data and/or the source code required to execute the simulations. Control proceeds to 1208.

At 1208, in response to obtaining the data and/or the source code, the failure mode simulation module 444 may automatically execute one or more simulations to simulate, model, and/or test each of the failure modes. The failure mode simulation module 444 may execute the simulations via one or more processes described herein. Control proceeds to 1212. At 1212, in response to the execution of the simulations, the monitoring module 442 may automatically verify each of the impact scores for each of the failure modes to ensure each of the impact scores are accurate. In response to the monitoring module 442 determining that an impact score is not accurate, the monitoring module 442 may automatically adjust and/or update the impact score or may prompt a user via a user interface 416 to adjust and/or update the impact score accordingly. Control proceeds to 1216.

At 1216, in response to verifying the impact scores, the monitoring module 442 may automatically verify each of the probability scores for each of the failure modes. In response to the monitoring module 442 determining that a probability score is not accurate, the monitoring module 442 may automatically adjust and/or update the probability score or may prompt a user via a user interface 416 to adjust and/or update the probability score accordingly. Control proceeds to 1220.

At 1220, in response to verifying the probability scores, the monitoring module 442 may automatically verify each of the detectability scores for each of the failure modes. In response to the monitoring module 442 determining that a detectability score is not accurate, the monitoring module 442 may automatically adjust and/or update the detectability score or may prompt a user via a user interface 416 to adjust and/or update the detectability score accordingly. Control proceeds to 1224.

At 1224, in response to verifying the detectability scores, the monitoring module 442 may automatically verify each of the risk priority scores for each of the failure modes. In response to the monitoring module 442 determining that a risk priority score is not accurate, the monitoring module 442 may automatically adjust and/or update the risk priority score or may prompt a user via a user interface 416 to adjust and/or update the risk priority score accordingly. Control proceeds to 1228. At 1228, in response to any of the impact scores, the probability scores, the detectability scores, and/or the risk priority scores being updated, the failure mode module 422 and/or the monitoring module 442 may save the updates to the FMEA database 500.

FIG. 13 is a flowchart of an example process for determining and facilitating execution of one or more remediation actions for each of the failure modes. In various implementations, a remediation action may refer to one or more processes and/or steps that may be executed automatically and/or by one or more organization members to address and/or resolve the identified failure modes. Control proceeds to 1304. At 1304, the failure mode module 422 may analyze, read, and/or load data associated with each of the failure modes for the system, the product, and/or the process under review of the FMEA. Control proceeds to 1308. At 1308, the failure mode module 422 may determine if any remediations actions are required to address and/or resolve each of the failure modes. If no at 1308, control ends. If yes at 1308, control proceeds to 1312.

At 1312, the failure mode module 422 may automatically generate one or more remediation action items for each of the failure modes. A remediation action item may include a specific task or action that may resolve a failure mode. Control proceeds to 1316. At 1316, the failure mode module 422 may automatically generate one or more code and/or configuration remediation actions. A code and/or configuration remediation action may include a code update and/or a configuration update that may resolve a failure mode. Control proceeds to 1320. At 1320, in response to generation a remediation action item and/or a code and/or configuration remediation action, the failure mode module 422 may automatically generate and send a notification (for example, an electronic message such as an email, etc.) to the each of the organization members assigned to the particular failure mode to facilitate the completion of the remediation action item and/or the code and/or configuration remediation action. Then control ends.

### User Interfaces

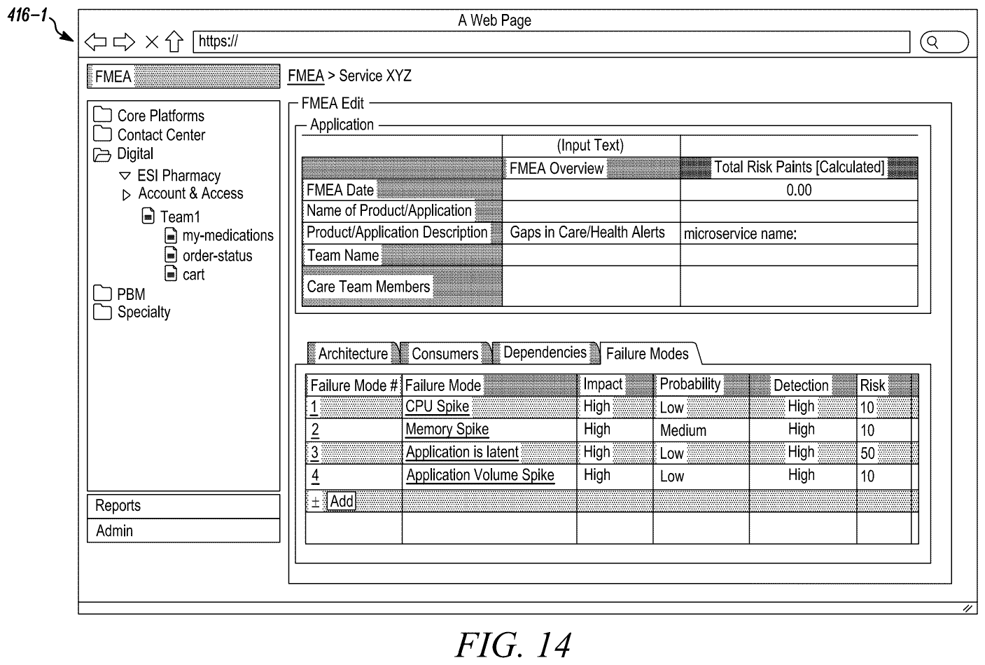

FIGS. 14-19 illustrate example user interfaces 416 that may used in connection with the FMEA system 400. Referring now to FIG. 14, a user interface 416-1 may display a product name (for example, gaps in care), a product description (for example, health alerts), one or more failure modes (for example, CPU spike, memory spike, application is latent, and application volume), an impact score for each failure mode (for example, high, high, low, high), a probability score for each failure mode (for example, low, medium, low, low), a detection score for each failure mode (for example, high, high, high, high, high), and/or a risk priority score for each failure mode (for example, 10, 10, 10, 50, 10), among others.

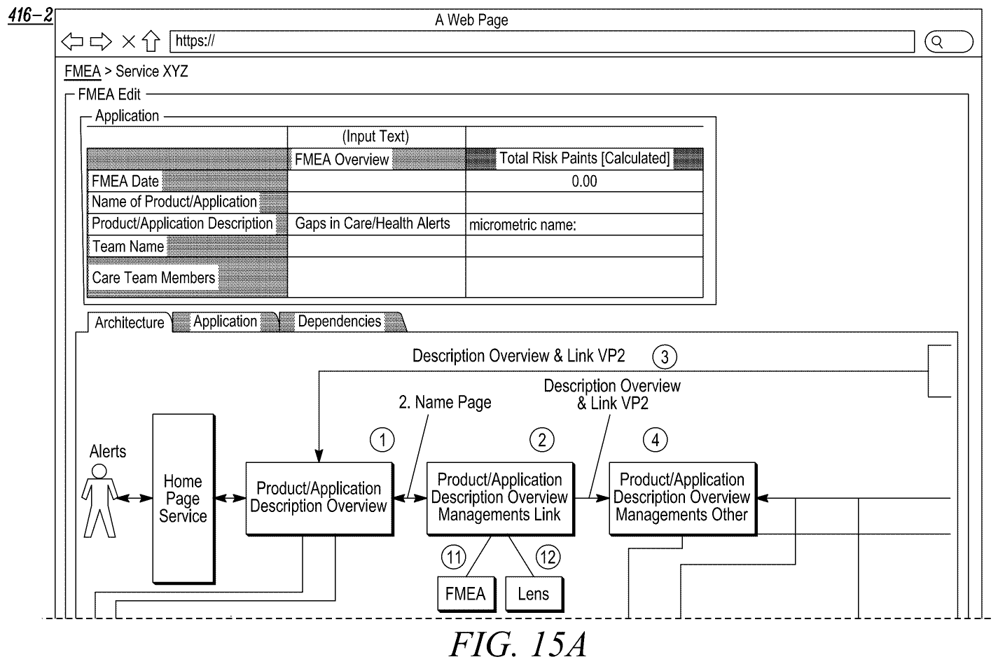

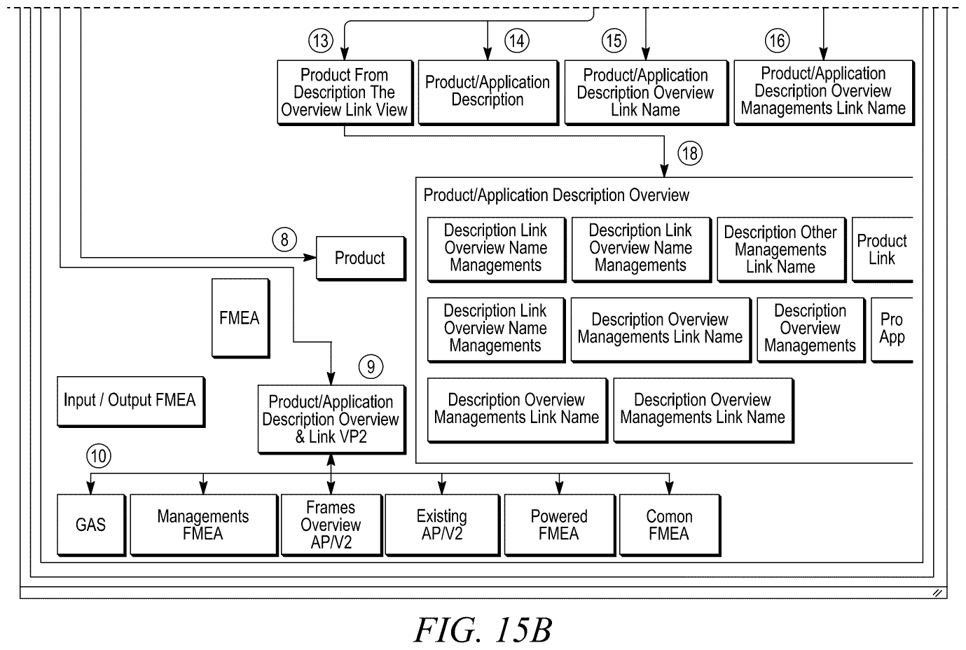

With reference to FIG. 15, a user interface 416-2 may display a dependency hierarchy map associated with the system, the product, and/or the process under review of the FMEA. The hierarchy map may be automatically generated via the FMEA system 400.

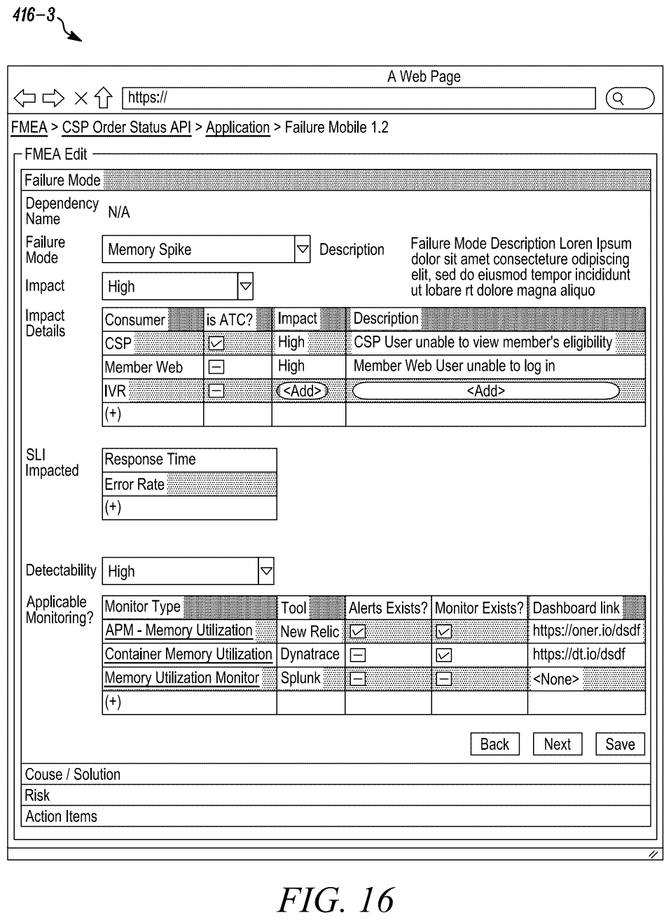

Referring now to FIG. 16, a user interface 416-3 may permit a user to view, select, add, and/or edit various details associated with each failure mode. For example, the user may view, select, add, and/or edit, a name of a failure mode, a description of the failure mode, an impact score, an impact details list, SLI impact details, a detectability score, and/or monitoring details, among others. In some examples, the impact details list may be auto populated based on dependency data. The impact score may be auto populated based on the impact details list. The monitoring details may be auto populated based on the system, the product, and/or the process associated with the failure mode. In some instances, the detectability score may be auto populated via a set of detectability rules. For example, if an alert exists, the detectability score may be classified as high. If no alert exists but monitoring exists, the detectability score may be classified as medium. Otherwise, the detectability score may be classified as low.

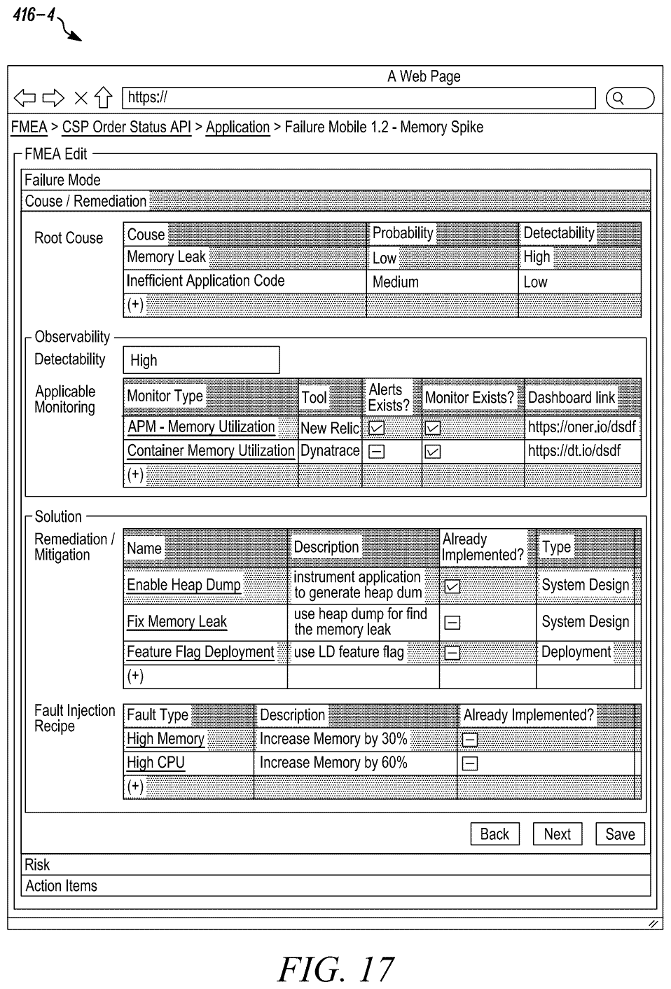

With reference to FIG. 17, a user interface 416-4 may permit a user to view, select, add, and/or edit various details associated with each root cause and each remediation action. For example, the user may view, select, add, and/or edit a name of each root cause (for example, memory leak, inefficient application code), a probability score associated with each root cause (for example, low, medium), a detectability score for each root cause (for example, high, low), monitoring details associated with each root cause, a name for each remediation action (for example, enable heap dump, fix memory leak, feature flag deployment), a description for each remediation action, a fault injection details associated with executing one or more simulations, a fault type (for example, high memory, high CPU), and/or a description for each fault, among others.

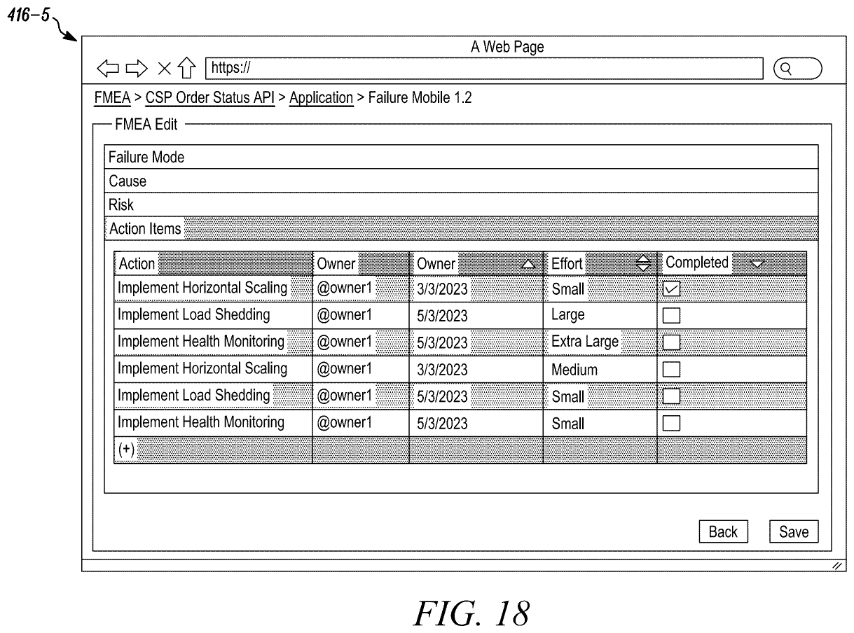

Referring now to FIG. 18, a user interface 416-5 may permit a user to view, select, add, and/or edit various details associated with each remediation action item. For example, the user may view, select, add, and/or edit a name and/or a description of each action item, one or more owners (i.e., organization members) assigned to each action item, a due date for each action item, an effort classification for each action item, and/or a completion identifier for each action item, among others.

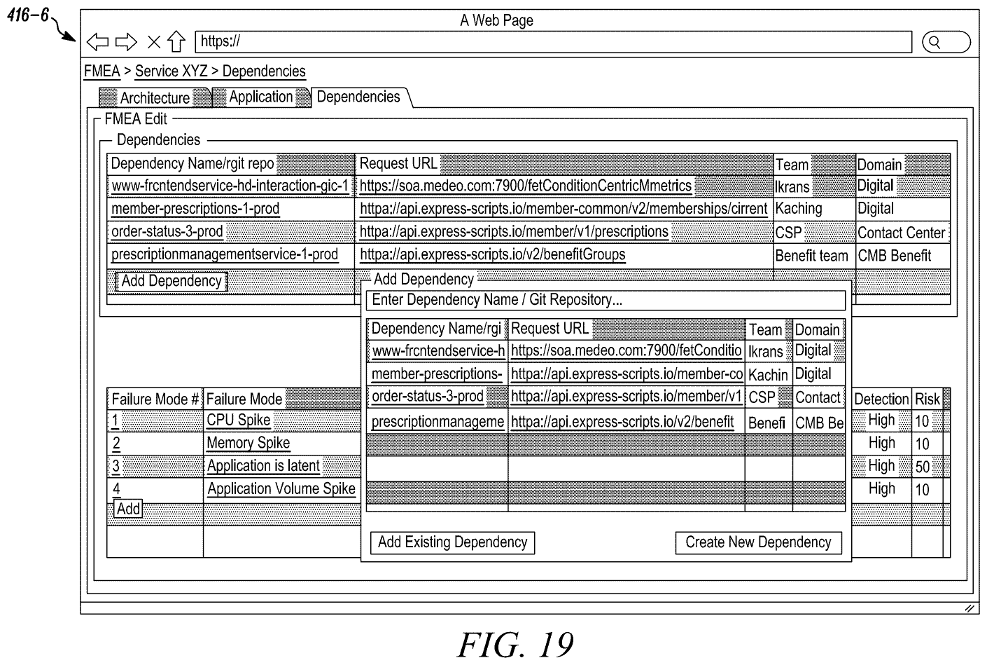

With reference to FIG. 19, a user interface 416-6 may permit a user to view, select, add, and/or edit various details associated with each dependency. For example, a user may view, select, add, and/or edit a name for each dependency, a URL associated with each dependency, an organization team assigned to each dependency, and/or a domain associated with each dependency, among others.

### Reports

FIGS. 20 and 21 illustrate example reports that may be generated via the report generation module 446. In various implementations, the report generation module 446 may be configured to generate various reports that are associated with the systems, the products, and/or the processes under review FMEA and/or results of failure mode simulations, among others. A user may select a type of report to generate via the user interface 416 and/or a report may be customizable via input from the user via the user interface 416.

Referring now to FIG. 20, a report 2000-1 may display a name and/or description for a specific failure mode (for example, memory spike), a failure mode ID (for example, FM1), an organization owner (for example, John Doe), a root cause (for example, memory leak), an impact score (for example, high), a probability score (for example, medium), a detectability score (for example, high), a risk priority score (for example, 10), and/or one or more remediation actions (for example, enable heap dump), among others. In various implementations, the report generation module 446 may query and/or aggregate various databases and/or data to generate the various reports (for example, the FMEA database 500, the failure mode database 502, the impact score data 504, the probability score data 506, the detectability score data 508, the risk priority score data 510, the root cause database 512, the improvement plan database 514, the FMEA artifacts data 516, the organization database 518, the configuration management database 520, and/or the failure mode simulation data 522, among others).

In various implementations, a report may display the organization members associated with particular systems, products, and/or process and/or failure modes, among others. A report may include all of the failure modes assigned to a particular set of organization members and/or organization business units, among others. A report may rank and/or display the failures modes in order of their risk priority scores with the highest scores listed first. In some instances, a report may indicate which organization business units are associated with the highest number of failure modes and/or the failures modes having the highest risk priority scores, among others. For example and without limitation, a report may include a percentage breakdown of the failures modes according to organization member and/or business unit, among others. For instance, a first organization member (for example, John Doe) and/or a first business unit (for example, pharmacy) may be associated with a first percentage of the failures modes (for example, 60%) and/or a second organization member (for example, Joe Smith) and/or a second business unit (for example, PBM) may be associated with a second percentage of the failures modes (for example, 40%), among others.

With reference to FIG. 21, a report 2000-2 may include one or more graphs that a user may customize via the user interface 416. For example, the report 2000-2 may include a bar graph that displays remediation action statuses. In various implementations, each bar of the bar graph may represent a remediation status for all FMEAs for a given aggregation (for example, organization team, domain, and/or product group, etc.). Each bar may include a first portion that indicates remediation actions that have been completed, a second portion that indicates remediation actions that have not been started, and/or a third portion that indicates remediation actions that are in progress.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set-in other words, in some circumstances a “set” may have zero elements. The term “non-empty set” may be used to indicate exclusion of the empty set-in other words, a non-empty set will always have one or more elements. The term “subset” does not necessarily require a proper subset. In other words, a “subset” of a first set may be coextensive with (equal to) the first set. Further, the term “subset” does not necessarily exclude the empty set-in some circumstances a “subset” may have zero elements.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.”

The term “module” may refer to, be part of, or include processor hardware (shared, dedicated, or group) that executes code and memory hardware (shared, dedicated, or group) that stores code executed by the processor hardware.

The module may include one or more interface circuit(s). In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A computer-implemented method for conducting failure mode effects analysis (FMEA) at a large scale, the method comprising:
generating a set of failure modes, wherein each of the failure modes is associated with at least one of a software system, a software product, or a software process;
determining an impact score for one of the set of failure modes, wherein the impact score is associated with a score that is a measure of a severity of a failure mode;
determining a probability score for one of the set of failure modes, wherein the probability score is associated with a score that is a measure of a frequency in which a failure mode is expected to occur;
determining a detectability score for one of the set of failure modes, wherein the detectability score is associated with a score that is a measure of a likelihood of detecting a failure mode;
calculating risk priority scores for the failure modes based on the impact score, the probability score, and the detectability score;
ranking the failure modes according to the calculated risk priority scores; and
generating a report including the ranked failure modes.

2. The method of claim 1 wherein generating the set of failure modes includes:
generating a FMEA artifact associated with at least one among the software system, the software product, and the software process;
determining a set of dependencies for the FMEA artifact, wherein a dependency is associated with a least one among a system, an application, a platform, and a component in which the at least one among the software system, the software product, and the software process requires to function properly; and
determining one or more failure modes associated with the set of dependencies.

3. The method of claim 2 wherein determining the one or more failure modes associated with the set of dependencies includes querying one or more databases to select data associated with failure modes of the set of dependencies.

4. The method of claim 1 further comprising assigning a set of organization members to each failure mode of the set of failures modes.

5. The method of claim 4 wherein assigning the set of organization members to each of the failure modes includes querying one or more databases to select the set of organization members.

6. The method of claim 1 further comprising generating an additional report by:
associating one or more organization members to each of the failure modes;
ranking the organization members according to the organization members associated with a highest number of failure modes; and
generating the additional report including the ranked organization members.

7. The method of claim 1 further comprising:
determining a root cause for each of the set of failure modes,
wherein the root cause is associated with a fundamental factor that if addressed can mitigate an occurrence of a failure mode.

8. The method of claim 1 further comprising:
determining an improvement plan for each of the set of failure modes,
wherein the improvement plan is associated with a plan to reduce the severity or an occurrence of a failure mode.

9. The method of claim 1 further comprising:
selecting a failure mode of the set of failure modes;
executing a failure mode simulation to test the selected failure mode; and
generating an additional report including results of the failure mode simulation.

10. The method of claim 1 further comprising displaying the report on an interactive user interface.

11. A system comprising:
processor hardware; and
memory hardware configured to store instructions that, when executed by the processor hardware, cause the processor hardware to perform operations, wherein the operations include:
generating a set of failure modes, wherein each of the failure modes is associated with at least one of a software system, a software product, or a software process;
determining an impact score for one of the set of failure modes, wherein the impact score is associated with a score that is a measure of a severity of a failure mode;
determining a probability score for one of the set of failure modes, wherein the probability score is associated with a score that is a measure of a frequency in which a failure mode is expected to occur;
determining a detectability score for one of the set of failure modes, wherein the detectability score is associated with a score that is a measure of a likelihood of detecting a failure mode;
calculating risk priority scores for the failure modes based on the impact score, the probability score, and the detectability score;
ranking the failure modes according to the calculated risk priority scores; and
generating a report including the ranked failure modes.

12. The system of claim 11 wherein generating the set of failure modes includes:
generating a FMEA artifact associated with at least one among the software system, the software product, and the software process;
determining a set of dependencies for the FMEA artifact, wherein a dependency is associated with a least one among a system, an application, a platform, and a component in which the at least one among the software system, the software product, and the software process requires to function properly; and
determining one or more failure modes associated with the set of dependencies.

13. The system of claim 12 wherein determining the one or more failure modes associated with the set of dependencies includes querying one or more databases to select data associated with failure modes of the set of dependencies.

14. The system of claim 11 wherein the operations further include assigning a set of organization members to each failure mode of the set of failures modes.

15. The system of claim 14 wherein assigning the set of organization members to each of the failure modes includes querying one or more databases to select the set of organization members.

16. The system of claim 11 wherein the operations further include generating an additional report by:
associating one or more organization members to each of the failure modes;
ranking the organization members according to the organization members associated with a highest number of failure modes; and
generating the additional report including the ranked organization members.

17. The system of claim 11 wherein the operations further include:
determining a root cause for each of the set of failure modes,
wherein the root cause is associated with a fundamental factor that if addressed can mitigate an occurrence of a failure mode.

18. The system of claim 11 wherein the operations further include:
determining an improvement plan for each of the set of failure modes,
wherein the improvement plan is associated with a plan to reduce the severity or an occurrence of a failure mode.

19. The system of claim 11 wherein the operations further include:
selecting a failure mode of the set of failure modes;
executing a failure mode simulation to test the selected failure mode; and
generating an additional report including results of the failure mode simulation.

20. A non-transitory computer-readable medium storing processor-executable instructions, the instructions comprising:
generating a set of failure modes, wherein each of the failure modes is associated with at least one of a software system, a software product, or a software process;
determining an impact score for one of the set of failure modes, wherein the impact score is associated with a score that is a measure of a severity of a failure mode;
determining a probability score for one of the set of failure modes, wherein the probability score is associated with a score that is a measure of a frequency in which a failure mode is expected to occur;
determining a detectability score for one of the set of failure modes, wherein the detectability score is associated with a score that is a measure of a likelihood of detecting a failure mode;
calculating risk priority scores for the failure modes based on the impact score, the probability score, and the detectability score;
ranking the failure modes according to the calculated risk priority scores; and
generating a report including the ranked failure modes.
